(19) United States
(12) Patent Application Publication
(10) Pub. No.: US 2025/0149552 A1
(43) Pub. Date: May 8, 2025

(54) ANODE MATERIAL AND PREPARATION METHOD THEREOF, AND LITHIUM ION BATTERY

(71) Applicant: BTR NEW MATERIAL GROUP CO., LTD., Shenzhen (CN)

(72) Inventors: Peng HE, Shenzhen (CN); Chengmao XIAO, Shenzhen (CN); Jianguo REN, Shenzhen (CN); Xueqin HE, Shenzhen (CN)

(21) Appl. No.: 19/020,611

(22) Filed: Jan. 14, 2025

Related U.S. Application Data
(63) Continuation of application No. PCT/CN2024/102624, filed on Jun. 28, 2024.

(30) Foreign Application Priority Data
Oct. 31, 2023 (CN) 202311426902.7
Oct. 31, 2023 (CN) 202311435362.9

(51) Int. Cl. H01M 4/36; H01M 4/38; H01M 4/587; H01M 4/62; H01M 10/0525; H01M 10/42

(52) U.S. Cl. CPC H01M 4/364; H01M 4/366; H01M 4/386; H01M 4/587; H01M 4/625; H01M 10/0525; H01M 10/4235

(57) ABSTRACT

Provided are anode material, as well as lithium ion battery. Anode prepared from anode material act as working electrode, metal lithium act as reference electrode, metal lithium acts as counter electrode, and electrolyte contains metal lithium ions, forming three-electrode battery for charging and discharging, and when anode material is electrified in de-intercalation direction, graph of relationship between differential value dQ/dV obtained by differentiating potential V of working electrode based on reference electrode to charge and discharge capacity Q and potential V of working electrode is obtained; and in graph of relationship between dQ/dV and potential V, differential value dQ/dV at potential V between 20 mV and 80 mV has maximum peak value A1, and differential value dQ/dV of potential V between 120 mV and 210 mV has maximum peak value B1, where B1/A1≤4.

### CROSS REFERENCE TO RELATED APPLICATIONS

This application is a continuation of International Application No. PCT/CN2024/102624, filed on Jun. 28, 2024, which claims the benefit of priority to Chinese Patent Application No. 202311426902.7, entitled “Anode material and Preparation Method Thereof, and Lithium Ion Battery”, filed on Oct. 31, 2023; Chinese Patent Application No. 202311435362.9, entitled “Anode material and Preparation Method Thereof, and Lithium Ion Battery”, filed on Oct. 31, 2023, the entire contents each of which are incorporated herein by reference for all purposes.

### TECHNICAL FIELD

The present disclosure relates to the technical field of anode materials, and in particular, to an anode material and a preparation method thereof, and a lithium ion battery.

### BACKGROUND

Lithium ion batteries have the advantages such as high energy density, long cycle life, low environmental pollution, and no memory effect, and thus are widely used in electric vehicles and consumer electronics. In recent years, the rapid development of electric vehicles has increased the demand for the lithium ion batteries with higher energy densities, which prompts researchers to search for battery materials with higher energy density and better cycling performance. The positive and anode materials are the core of the batteries, and determine the operating efficiency of the batteries. At present, the commercial anode material is graphite, the capacity of which is already close to the theoretical upper limit, leaving limited room for further enhancement. Therefore, there is an urgent need to develop a new generation of anode material with high energy density. Silicon-based anode materials are generally considered as a next-generation anode material for batteries, and has advantages such as high capacity, abundant resources, and relative safety.

However, silicon anodes experience significant volume expansion during cycling, which leads to material pulverization, fracturing, and rapid cycling degradation. In view of this issue, multiple solutions have been proposed, including structural design of silicon, adopting techniques such as nanomization and porosity, composite coating methods, and the use of novel electrolytes and binders to improve silicon pole pieces. Among these, nanomization is one of the mainstream approaches. The silicon size is reduced to a nanoscale, reducing the expansion of the silicon, and preventing the pulverization of the silicon. However, existing nanomization solutions have many shortcomings in solving the performance of silicon, and the long-cycling performance has a significant improvement space.

### SUMMARY

The embodiment of the present disclosure provides an anode material and a preparation method thereof, and a lithium ion battery, which can effectively inhibit the volume expansion of the anode material and improve the cycling performance of the anode material.

According to a first aspect, an embodiment of the present disclosure provides an anode material, including an active material. The active material includes a carbon matrix and silicon material, the carbon matrix has pores, and at least part of the silicon material are distributed in the pores of the carbon matrix.

An anode prepared from the anode material acts as a working electrode, a metal lithium acts as a reference electrode, the metal lithium acts as a counter electrode, and an electrolyte contains metal lithium ions. The reference electrode, the counter electrode, and the electrolyte form a three-electrode battery for charging and discharging, and when the anode material is electrified in a de-intercalation direction, a graph of a relationship between a differential value dQ/dV obtained by differentiating a potential V of the working electrode based on the reference electrode to a charge and discharge capacity Q and the potential V of the working electrode is obtained.

In the graph of the relationship between dQ/dV and the potential V, the differential value dQ/dV of the potential V between 20 mV and 80 mV has a maximum peak value A1, and the differential value dQ/dV of the potential V between 120 mV and 210 mV has a maximum peak value B1, where B1/A1≤4.

According to a second aspect, the present disclosure further provides another anode material, including an active material. The active material includes a carbon matrix and silicon material, the carbon matrix has pores, and at least part of the silicon material are distributed in the pores of the carbon matrix.

An anode prepared from the anode material acts as an working electrode, a metal lithium acts as a reference electrode, the metal lithium acts as a counter electrode, and an electrolyte contains metal lithium ions, forming a three-electrode battery for charging and discharging, and when the anode material is electrified in a de-intercalation direction, a graph of a relationship between a differential value dQ/dV obtained by differentiating a potential V of the working electrode based on the reference electrode to a charge and discharge capacity Q and the potential V of the working electrode is obtained.

in the graph of the relationship between the differential value dQ/dV and the potential V, the differential value dQ/dV of the potential V between 200 mV and 350 mV has a maximum peak value A2, with a half-peak width F1, and the differential value dQ/dV of the potential V between 380 mV and 470 mV has a maximum peak value B2, with a half-peak width F2, where A2>B2, and a following relationship is satisfied: (B2*F2)/(A2*F1)≤0.35.

According to a third aspect, the present disclosure provides a lithium ion battery. The lithium ion battery includes the foregoing anode material.

Compared with the related art, the technical solution of the present disclosure has at least the following beneficial effects:

According to the anode material provided in the first aspect of the present disclosure, the anode material includes the active material. The active material includes the carbon matrix and the silicon material, the carbon matrix has the pores, at least part of the silicon material are distributed in the pores of the carbon matrix, thereby improving the capacity of the anode material. The differential value dQ/dV of the potential V between 20 mV and 80 mV has the maximum peak value A1 that can represent the peak intensity formed when an amorphous lithium-silicon alloy undergoes an amorphous-to-crystalline phase transition at a low de-intercalation potential. The differential value dQ/dV of the potential V between 120 mV and 210 mV has a maximum peak value B1 that represents the peak intensity formed by lithium and silicon with a particle size greater than 5 nm during the lithium de-intercalation process. By controlling the value of B1/A1 within the aforementioned range, the formation of large-size silicon material and lithium-silicon alloy in the anode material can be reduced, ensuring that the anode material can alleviate volume expansion during cycling, maintaining the structural stability, reducing the collapse of the material structure due to volume expansion of the anode material during the lithium intercalation and de-intercalation process, and effectively reducing side reactions between the anode material and the electrolyte, thereby improving the cycling performance of the anode material.

According to the anode material provided in the second aspect of the present disclosure, the anode material includes the active material. The active material includes the carbon matrix and the silicon material, the carbon matrix has the pores, at least part of the silicon material are distributed in the pores of the carbon matrix, thereby improving the capacity of the anode material. when the anode material is electrified in the de-intercalation direction, the differential value dQ/dV of the potential V between 200 mV and 350 mV has the maximum peak value of A2, with the half-peak width F1, and the differential value dQ/dV of the potential V between 380 mV and 470 mV has the maximum peak value of B2, with the half-peak width F2, where A2>B2. The anode material satisfies the relationship: (B2*F2)/(A2*F1)≤0.35. The value of (B2*F2)/(A2*F1) is controlled within the above range, which can ensure that the silicon material are uniformly filled in the pores of the carbon matrix instead of the surface of the carbon matrix, so that the silicon material are uniformly filled in the pores of the carbon matrix, and meanwhile, the formation of large-size silicon material can be reduced, thereby reducing the volume expansion of the anode material to obtain the anode material with lower expansion and better cycling performance.

### BRIEF DESCRIPTION OF DRAWINGS

FIG. 1 shows a V-dQ/dV test graph of a anode material according to the first aspect of the present disclosure;

FIG. 2 shows a V-dQ/dV test graph of a anode material according to the second aspect of the present disclosure;

FIG. 3 shows a scanning electron microscope (SEM) image of a anode material prepared in Example 1 of the present disclosure;

FIG. 4 shows an X-ray diffraction (XRD) pattern of the anode material prepared in Example 1 of the present disclosure;

FIG. 5 shows a first charge-discharge curve of the anode material prepared in Example 1 of the present disclosure;

FIG. 6 shows a cycling performance curve of the anode material prepared in Example 1 of the present disclosure;

FIG. 7 shows a scanning electron microscope (SEM) image of a anode material prepared in Example 9 of the present disclosure;

FIG. 8 shows an XRD pattern of the anode material prepared in Example 9 of the present disclosure;

FIG. 9 shows a first charge-discharge curve of the anode material prepared in Example 9 of the present disclosure; and

FIG. 10 shows a cycling performance curve of the anode material prepared by Example 9 of the present disclosure.

### DESCRIPTION OF EMBODIMENTS

In order to better understand the technical solutions of the specification, detailed description of embodiments of the present disclosure will be provided below in conjunction with the accompanying drawings.

It should be made clear that the embodiments described are only part of rather than all of the embodiments of the present disclosure. Based on the embodiments in the present disclosure, all other embodiments obtained by those skilled in the art without any creative efforts fall within the scope of the present disclosure.

The terms used in the embodiments of the present disclosure are merely for the purpose of describing particular embodiments but not intended to limit this specification. The terms “a”, “an”, “the”, and “said” in a singular form in an embodiment of the present disclosure and the attached claims are also intended to include plural forms thereof, unless explicitly noted otherwise in the context.

It should be understood that the term “and/or” used herein is merely an association relationship describing an associated object, indicating that there may be three relationships, for example, A and/or B, and may indicate: only A, both A and B, and only B. In addition, the character “/” herein generally means an “or” relationship between the preceding and subsequent associated objects.

According to a first aspect, an embodiment of the present disclosure provides an anode material, including an active material. The active material includes a carbon matrix and silicon material, the carbon matrix has pores, and at least part of the silicon material are distributed in the pores of the carbon matrix.

A anode prepared from the anode material is used as an working electrode, a metal lithium is used as a reference electrode, the metal lithium is used as a counter electrode, and an electrolyte contains metal lithium ions, forming a three-electrode battery for charging and discharging, and when the anode material is electrified in a de-intercalation direction, a graph of a relationship between a differential value dQ/dV obtained by differentiating a potential V of the working electrode based on the reference electrode to a charge and discharge capacity Q and the potential V of the working electrode is obtained.

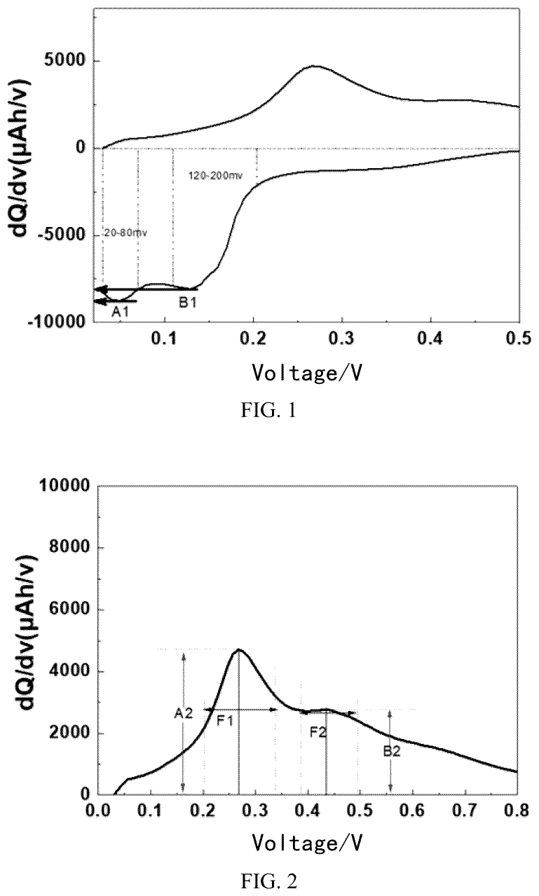

As shown in FIG. 1, in the graph of the relationship between dQ/dV and the potential V, the differential value dQ/dV at the potential V between 20 mV and 80 mV has a maximum peak value A1, and the differential value dQ/dV at the potential V between 120 mV and 210 mV has a maximum peak value B1, where B1/A1≤4.

According to the anode material provided by the present disclosure, the anode material includes the active material. The active material includes the carbon matrix and the silicon material, the carbon matrix has the pores, at least part of the silicon material are distributed in the pores of the carbon matrix, thereby improving the capacity of the anode material. The differential value dQ/dV of the potential V between 20 mV and 80 mV has the maximum peak value A1 that can represent the peak intensity formed when an amorphous lithium-silicon alloy undergoes an amorphous-to-crystalline phase transition at a low de-intercalation potential. The differential value dQ/dV of the potential V between 120 mV and 210 mV has a maximum peak value B1 that represents the peak intensity formed by lithium and silicon with a particle size greater than 5 nm during the lithium de-intercalation process. By controlling the value of B1/A1 within the aforementioned range, the formation of large-size silicon material and lithium-silicon alloy in the anode material can be reduced, ensuring that the anode material can alleviate volume expansion during cycling, maintaining the structural stability, reducing the collapse of the material structure due to volume expansion of the anode material during the lithium intercalation and de-intercalation process, and effectively reducing side reactions between the anode material and the electrolyte, thereby improving the cycling performance of the anode material.

The value of B1/A1 may specifically be 4, 3.9, 3.85, 3.42, 3.27, 2.86, 2.65, 2.45, 2.36, 2.27, 1.98, 1.86, 1.59, 1.47, 1.34, 1.22, 1.05, 0.98, 0.54, or 0.37, etc., or may be another value within the above range, which is not limited herein. When the value of B1/A1 is within the above range, the silicon material are deposited in the pores of the carbon matrix and have a small size, and the proportion of surface silicon and large-particle silicon in the anode material is reduced, thereby reducing the volume expansion of the anode material, and improving the cycling performance of the anode material.

In some embodiments, the carbon matrix includes at least one of hard carbon, soft carbon, graphite, mesocarbon microbeads, activated carbon, porous carbon, mesoporous carbon, and carbon gel.

In some embodiments, the total pore volume of the anode material after removing the silicon material is greater than or equal to 0.4 cm³/g, which may specifically be 0.4 cm³/g, 0.5 cm³/g, 0.8 cm³/g, 1 cm³/g, 1.1 cm³/g, 1.3 cm³/g, 1.5 cm³/g, or 1.8 cm³/g, etc., or may be another value within the above range, which is not limited herein. Preferably, the total pore volume of the anode material after removing the silicon material is greater than or equal to 0.5 cm³/g. More preferably, the total pore volume of the anode material after removing the silicon material is greater than or equal to 0.7 cm³/g. The anode material after removing the silicon material ideally corresponds to the carbon matrix. An etching method is as follows: under stirring conditions, 150 mL of 20% by mass of HF acid solution is added into 10 g of anode material dropwise to obtain a mixture solution and produce SiF₄, H₂ gas, and heat. After no more gas is generated, the mixture solution is centrifuged to remove a supernatant acid solution. Then 150 mL of 20% by mass HF acid solution is added into the anode material again for 12 hours of stirring, and centrifugation is performed to remove a supernatant acid solution again; then, the anode material is washed with pure water until the anode material becomes neutral and then the anode material is dried to obtain an anode material with silicon material being removed, i.e., the matrix.

In some embodiments, the pores in the anode material after removing the silicon material include micropores having a pore diameter less than 2 nm, and a ratio of the micropores is greater than or equal to 80%. The ratio of the micropores may specifically be 80%, 82%, 85%, 88%, 90%, 92%, 93%, 95%, 98% or 99%, etc., which is not limited herein. It can be understood that, the size of the silicon material deposited in the pores of the carbon matrix is determined by the size of the pores. The higher the ratio of micropores, the smaller the average pore diameter of the pores, and the smaller the silicon material deposited in the pores. Smaller silicon material deposited in the pores of the carbon matrix lead to less volume expansion of the anode material during cycling, improving the cycling performance of the anode material. Preferably, the ratio of micropores is greater than or equal to 90%. More preferably, the ratio of micropores is greater than or equal to 95%.

In some embodiments, the average pore diameter of the pores in the anode material after removing the silicon material is less than or equal to 5 nm, which may specifically be 0.1 nm, 0.5 nm, 1 nm, 1.5 nm, 2 nm, 2.5 nm, 3 nm, 3.5 nm, 4 nm, 4.5 nm, or 5 nm, etc., or may be another value within the above range, which is not limited herein. Preferably, the average pore diameter of the pores in the anode material after removing the silicon material is less than or equal to 2 nm. More preferably, the average pore diameter of the pores in the anode material after removing the silicon material is less than or equal to 1.8 nm.

In some embodiments, the porosity of the anode material after removing the silicon material is 40% to 60%, which may specifically be 40%, 41%, 43%, 45%, 48%, 50%, 52%, 54%, 56%, 58%, or 60%, etc., or may be another value within the above range, which is not limited herein.

In some embodiments, the silicon material include at least one of silicon element, silicon oxide, silicon alloy, and silicon-carbon composite. In an example, the silicon element may be amorphous silicon, crystalline silicon, or a composite of crystalline silicon and amorphous silicon, etc., which is not limited herein. The silicon alloy may be silicon lithium alloy, silicon magnesium alloy, or silicon nickel alloy, etc., which is not limited herein.

In some embodiments, the average particle size of the silicon material is 1 nm to 500 nm, which may specifically be 1 nm, 5 nm, 10 nm, 50 nm, 100 nm, 150 nm, 200 nm, 300 nm, 350 nm, 400 nm, or 500 nm, etc., or may be another value within the above range, which is not limited herein. Preferably, the average particle size of the silicon material is 1 nm to 50 nm. More preferably, the average particle size of the silicon material is 1 nm to 10 nm.

In some embodiments, a mass content of silicon element in the silicon material is greater than or equal to 99%. The mass content of silicon in the silicon material is within the above range, which is conducive to improving the purity of the silicon material and reducing impurities.

In some embodiments, the anode material further includes a carbon layer on at least part of a surface of the active material. It can be understood that, the carbon layer can be used as a buffer layer to reduce the volume expansion effect of the anode material to a certain extent, while enhancing the conductivity of the anode material. The carbon layer can further reduce the direct contact between the active material and the electrolyte, inhibiting the excessive growth of a solid electrolyte interphase (SEI) film on the surface of the anode material, stabilizing the interface of the anode material, and improving the coulombic efficiency of the anode material.

In some embodiments, the anode material further includes a carbon layer on at least part of the surface of the active material, and the carbon layer includes at least one of graphitic carbon and amorphous carbon.

In some embodiments, the median particle diameter D50 of the anode material is less than or equal to 10 μm, which may specifically be 0.5 μm, 1 μm, 2 μm, 3 μm, 4 μm, 5 μm, 6 μm, 7 μm, 8 μm, 9 μm, or 10 μm, etc., or may be another value within the above range, which is not limited herein. It can be understood that, the median particle size of the anode material is controlled within the above range, which is conducive to improving the cycling performance of the anode material.

In some embodiments, the specific surface area of the anode material is less than or equal to 5 m²/g, which may specifically be 0.1 m²/g, 0.5 m²/g, 1 m²/g, 1.5 m²/g, 2 m²/g, 2.5 m²/g, 3 m²/g, 3.5 m²/g, 4 m²/g, 4.5 m²/g, or 5 m²/g, etc., or may be another value within the above range, which is not limited herein. The specific surface area of the anode material is controlled within the above range, which is conducive to improving the first efficiency and cycling performance of the lithium battery made of the anode material.

According to a second aspect, an embodiment of the present disclosure provides an anode material, including an active material. The active material includes a carbon matrix and silicon material, the carbon matrix has pores, and at least part of the silicon material are distributed in the pores of the carbon matrix.

A anode prepared from the anode material is used as an working electrode, a metal lithium is used as a reference electrode, the metal lithium is used as a counter electrode, and an electrolyte contains metal lithium ions, forming a three-electrode battery for charging and discharging, and when the anode material is electrified in a de-intercalation direction, a graph of a relationship between a differential value dQ/dV obtained by differentiating a potential V of the working electrode based on the reference electrode to a charge and discharge capacity Q and the potential V of the working electrode is obtained.

As shown in FIG. 2, in the graph of the relationship between dQ/dV and the potential V, the differential value dQ/dV of the potential V between 200 mV and 350 mV has the maximum peak value of A2, with the half-peak width F1, and the differential value dQ/dV of the potential V between 380 mV and 470 mV has the maximum peak value of B2, with the half-peak width F2, where A2>B2. The anode material satisfies the relationship: (B2*F1)/(A2*F2)≤0.35.

According to the anode material provided by the present disclosure, the anode material includes the active material. The active material includes the carbon matrix and the silicon material, the carbon matrix has the pores, at least part of the silicon material are distributed in the pores of the carbon matrix, thereby improving the capacity of the anode material. when the anode material is electrified in the de-intercalation direction, the differential value dQ/dV of the potential V between 200 mV and 350 mV has the maximum peak value of A2, with the half-peak width F1, and the differential value dQ/dV of the potential V between 380 mV and 470 mV has the maximum peak value of B2, with the half-peak width F2, where A2>B2. The anode material satisfies the relationship: (B2*F1)/(A2*F2)≤0.35. In this solution, the peak value A2 can represent the peak intensity formed when an amorphous lithium-silicon alloy undergoes an amorphous-to-crystalline phase transition at a low de-intercalation potential, and the peak value B2 can represent the peak intensity formed by lithium and silicon with a particle size greater than 5 nm during the lithium de-intercalation process. The value of (B2*F1)/(A2*F2) is controlled within the above range, which can ensure that the silicon material are uniformly filled in the pores of the carbon matrix instead of the surface of the carbon matrix, so that the silicon material are uniformly filled in the pores of the carbon matrix, and meanwhile, the formation of large-size silicon material can be reduced, thereby reducing the volume expansion of the anode material to obtain the anode material with lower expansion and better cycling performance.

A value of (B2*F1)/(A2*F2) may specifically be 0.01, 0.5, 0.8, 0.1, 0.12, 0.15, 0.18, 0.2, 0.23, 0.25, 0.28, 0.3, 0.32, or 0.35, etc., or may be another value within the above range, which is not limited herein. The value of (B2*F1)/(A2*F2) is controlled within the above range, which can ensure that the silicon material can be uniformly filled in the pores of the carbon matrix, and ensure that the size of the silicon material is not too large, so that the proportion of the surface silicon and the large-particle silicon in the anode material is reduced, thereby reducing the volume expansion of the anode material to obtain the anode material with lower expansion and better cycling performance.

In some embodiments, the carbon matrix includes at least one of hard carbon, soft carbon, graphite, mesocarbon microbeads, activated carbon, porous carbon, mesoporous carbon, or carbon gel.

In some embodiments, the total pore volume of the carbon matrix is greater than or equal to 0.4 cm³/g, which may specifically be 0.4 cm³/g, 0.5 cm³/g, 0.8 cm³/g, 1 cm³/g, 1.1 cm³/g, 1.3 cm³/g, 1.5 cm³/g, or 1.8 cm³/g, etc., or may be another value within the above range, which is not limited herein. Preferably, the total pore volume of the carbon matrix is greater than or equal to 0.5 cm³/g. More preferably, the total pore volume of the carbon matrix is greater than or equal to 0.7 cm³/g.

In some embodiments, the pores of the carbon matrix include micropores, and a ratio of the micropores is greater than or equal to 80%. The ratio of the micropores may specifically be 80%, 82%, 85%, 88%, 90%, 92%, 93%, 95%, 98% or 99%, etc., which is not limited herein. It can be understood that, the size of the silicon material deposited in the pores of the carbon matrix is determined by the size of the pores. The higher the ratio of micropores, the smaller the average pore diameter of the pores of the carbon matrix, and the smaller the particle size of the silicon material deposited in the pores of the carbon matrix. Smaller particle size of the silicon material deposited in the carbon matrix pores leads to less volume expansion of the anode material during cycling, improving the cycling performance of the anode material. Preferably, the ratio of micropores is greater than or equal to 90%. More preferably, the ratio of micropores is greater than or equal to 95%.

In some embodiments, the average pore diameter of the pores of the carbon matrix is less than or equal to 5 nm, which may specifically be 0.1 nm, 0.5 nm, mm, 1.5 nm, 2 nm, 2.5 nm, 3 nm, 3.5 nm, 4 nm, 4.5 nm, or 5 nm, etc., or may be another value within the above range, which is not limited herein. Preferably, the average pore diameter of the pores of the carbon matrix is less than or equal to 2 nm. More preferably, the average pore diameter of the pores of the carbon matrix is less than or equal to 1.8 nm.

In some embodiments, the silicon material include at least one of amorphous silicon, crystalline silicon, silicon oxide, silicon alloy, and a composite of crystalline silicon and amorphous silicon.

In some embodiments, the average particle size of the silicon material is mm to 500 nm, which may specifically be mm, 5 nm, 10 nm, 50 nm, 100 nm, 150 nm, 200 nm, 300 nm, 350 nm, 400 nm, or 500 nm, etc., or may be another value within the above range, which is not limited herein. Preferably, the average particle size of the silicon material is mm to 50 nm. More preferably, the average particle size of the silicon material is mm to 10 nm.

In some embodiments, a mass content of silicon in the silicon material is greater than or equal to 99%.

In some embodiments, the anode material further includes a carbon layer on a surface of the active material. It can be understood that, the carbon layer can be used as a buffer layer to reduce the volume expansion effect of the anode material to a certain extent, while enhancing the conductivity of the anode material. The carbon layer can further reduce the direct contact between the silicon material and the electrolyte, inhibiting the excessive growth of a SEI film on the surface of the anode material, stabilizing the interface of the anode material, and improving the coulombic efficiency of the anode material.

In some embodiments, the anode material further includes a carbon layer on the surface of the active material, and the carbon layer includes an amorphous carbon material.

In some embodiments, the median particle diameter D50 of the anode material is less than or equal to 10 μm, which may specifically be 0.5 μm, 1 μm, 2 μm, 3 μm, 4 μm, 5 μm, 6 μm, 7 μm, 8 μm, 9 μm, or 10 μm, etc., or may be another value within the above range, which is not limited herein. The median particle size of the anode material is controlled within the above range, which is beneficial to improving the cycling performance of the lithium ion battery made of the anode material.

In some embodiments, the specific surface area of the anode material is less than or equal to 5 m²/g, which may specifically be 0.1 m²/g, 0.5 m²/g, 1 m²/g, 1.5 m²/g, 2 m²/g, 2.5 m²/g, 3 m²/g, 3.5 m²/g, 4 m²/g, 4.5 m²/g, or 5 m²/g, etc., or may be another value within the above range, which is not limited herein. The specific surface area of the anode material is controlled within the above range, which is conducive to improving the first efficiency and cycling performance of the lithium battery made of the anode material.

According to a third aspect, the present disclosure provides a preparation method of the anode material, including the following steps:

Step S100, a carbon matrix with pores is provided.

Step S200, vapor deposition is performed on the carbon matrix with pores using a silicon source gas to obtain an active material. The anode material includes the active material. The average pore diameter of the carbon matrix is Dnm, the volume concentration ratio of the silicon source gas is N, the flow rate of the silicon source gas is VL/min, the deposition time of the vapor deposition is t hours, the deposition temperature of the vapor deposition is T° C., and a deposition relationship is controlled to satisfy: K=(10³V²ND³)/(t²T^{1.5}), where 1.1≤K≤6.5.

According to the preparation method of the anode material provided by the present disclosure, the silicon material are fully filled in the pores of the carbon matrix using a vapor deposition process to prepare the anode material. The deposition of the silicon material on the surface of the carbon matrix can be reduced by controlling deposition conditions, and the silicon material are effectively filled in the pores of the carbon matrix, improving the capacity of the anode material. Meanwhile, the size and shape of the silicon material can be controlled to ensure that the anode material not only can relieve volume expansion but also can maintain structural stability during cycling, reducing the collapse of the material structure caused by volume expansion of the anode material during the lithium intercalation and de-intercalation process, and effectively reducing the occurrence of side reactions, thereby improving the cycling performance of the anode material.

Step S100, the carbon matrix with pores is provided.

It should be noted that, the carbon matrix with pores in the present disclosure may be directly purchased and used, or may be prepared by carbonizing a carbon source, which is not limited herein.

In some embodiments, the step of providing the carbon matrix with pores includes: after the carbon source is carbonized, the product of the carbonization treatment is subjected to acid pickling and activation treatment to obtain the carbon matrix with pores.

In some embodiments, the carbon source includes at least one of husks, starch, coconut shells, rice shells, coal, lignin, sugars, thermoplastic polyurethane (TPU), polylactide, polyglycolide, polyaniline, phenolic resin, polyamide, polyacrylonitrile, polychloroprene, polyphosphate, etc.

In some embodiments, the temperature of the carbonization treatment is 400° C. to 1800° C., which may specifically be 400° C., 500° C., 800° C., 1000° C., 1200° C., 1500° C., 1600° C., or 1800° C., etc., which is not limited herein. The time of the carbonization treatment is 1 h to 15 h, which may specifically be 1 h, 3 h, 5 h, 8 h, 10 h, 12 h, 13 h, 14 h, or 15 h, etc., which is not limited herein.

In some embodiments, the step of acid pickling the product of the carbonization treatment includes: the product of the carbonization treatment is placed in an acid solution with a concentration of 1 mol/L to 20 mol/L for 0.5 hours to 20 hours.

In some embodiments, the step of acid pickling the product of the carbonization treatment includes: the product of the carbonization treatment is placed in an acid solution with a concentration of 1 mol/L to 20 mol/L for 0.5 hours to 20 hours. The acid solution includes at least one of hydrochloric acid, nitric acid, sulfuric acid, carbonic acid, acetic acid, benzoic acid, hydrofluoric acid, oxalic acid and phosphoric acid.

The concentration of the acid solution may specifically be 1 mol/L, 3 mol/L, 5 mol/L, 6 mol/L, 8 mol/L, 10 mol/L, 12 mol/L, 15 mol/L, 18 mol/L, or 20 mol/L, etc., which is not limited herein.

The time for placing the product of the carbonization treatment in the acid solution may specifically be 0.5 h, 0.8 h, 1 h, 2 h, 3 h, 5 h, 8 h, 12 h, 15 h, 18 h, or 20 h, etc., which is not limited herein.

In some embodiments, the step of activating the product of the carbonization treatment includes: the product of the carbonization treatment after acid pickling is dried and then placed in a mixed gas of nitrogen and water vapor for activation treatment. It can be understood that the acid pickling and activation treatment are conducive to the directional deposition of silicon material into the pores of the carbon matrix during the subsequent silicon deposition process, thereby reducing the deposition of silicon material on the surface of the carbon matrix.

In some embodiments, the step of activating the product of the carbonization treatment includes: the product of the carbonization treatment after acid pickling is dried and then placed in a mixed gas of nitrogen and water vapor for activation treatment. The volume ratio of the water vapor to the nitrogen is (0.1-20):80. The volume ratio of water vapor to nitrogen gas may specifically be 0.1:80, 1:80, 2:80, 3:80, 5:80, 8:80, 10:80, 12:80, 15:80, 18:80, or 20:80, etc., which is not limited herein.

In some embodiments, the step of activating the product of the carbonization treatment includes: the product of the carbonization treatment after acid pickling is dried and then placed in a mixed gas of nitrogen and water vapor for activation treatment. The temperature of the activation treatment is 400° C. to 2000° C., and the time of the activation treatment is 0.5 hours to 30 hours.

The temperature of the activation treatment may specifically be 400° C., 500° C., 800° C., 1000° C., 1200° C., 1500° C., 1800° C., or 2000° C., etc., which is not limited herein. The time of the activation treatment may specifically be 0.5 h, 1 h, 3 h, 5 h, 8 h, 10 h, 12 h, 15 h, 18 h, 24 h, or 30 h, etc., which is not limited herein.

In some embodiments, the carbon matrix includes at least one of hard carbon, soft carbon, graphite, mesocarbon microbeads, activated carbon, porous carbon, mesoporous carbon, and carbon gel.

In some embodiments, the total pore volume of the carbon matrix is greater than or equal to 0.4 cm³/g, which may specifically be 0.4 cm³/g, 0.5 cm³/g, 0.8 cm³/g, 1 cm³/g, 1.1 cm³/g, 1.3 cm³/g, 1.5 cm³/g, or 1.8 cm³/g, etc., or may be another value within the above range, which is not limited herein. Preferably, the total pore volume of the carbon matrix is greater than or equal to 0.5 cm³/g. More preferably, the total pore volume of the carbon matrix is greater than or equal to 0.7 cm³/g.

In some embodiments, the pores include micropores having a pore diameter less than 2 nm, and a ratio of the micropores is greater than or equal to 80%. The ratio of the micropores may specifically be 80%, 82%, 85%, 88%, 90%, 92%, 93%, 95%, 98% or 99%, etc., which is not limited herein. Preferably, the ratio of micropores is greater than or equal to 90%. More preferably, the ratio of micropores is greater than or equal to 95%.

In some embodiments, the average pore diameter of the pores of the carbon matrix is less than or equal to 5 nm, which may specifically be 0.1 nm, 0.5 nm, 1 nm, 1.5 nm, 2 nm, 2.5 nm, 3 nm, 3.5 nm, 4 nm, 4.5 nm, or 5 nm, etc., or may be another value within the above range, which is not limited herein. Preferably, the average pore diameter of the pores of the carbon matrix is less than or equal to 2 nm. More preferably, the average pore diameter of the pores of the carbon matrix is less than or equal to 1.8 nm.

In some embodiments, the porosity of the carbon matrix is 40% to 60%, which may specifically be 40%, 41%, 43%, 45%, 48%, 50%, 52%, 54%, 56%, 58%, or 60%, etc., or may be another value within the above range, which is not limited herein.

Step S200, vapor deposition is performed on the carbon matrix with pores using a silicon source gas to obtain an active material. The anode material includes the active material. The average pore diameter of the carbon matrix is Dnm, the volume concentration ratio of the silicon source gas is N, the flow rate of the silicon source gas is VL/min, the deposition time of the vapor deposition is t hours, the deposition temperature of the vapor deposition is T° C., and a deposition relationship is controlled to satisfy: K=(10³V²ND³)/(t²T^{1.5}), where 1.1≤K≤6.5.

A value of K may specifically be 1.1, 1.24, 1.58, 1.69, 1.86, 2.05, 2.87, 3, 3.12, 3.5, 3.8, 3.97, 4, 4.3, 4.5, 4.8, 5.2, 5.4, 5.7, 6, 6.1, 6.38, 6.4, 6.45, 6.48, or 6.5, etc., which is not limited herein. Controlling the K value within the above range is conducive to filling the pores of the carbon matrix with the silicon material, reducing the generation of surface silicon and large-particle silicon, and controlling the size of the silicon material at the micro-nano level, thereby alleviating the volume expansion of the anode material, effectively reducing the occurrence of side reactions, and improving the cycling performance of the anode material.

In some embodiments, the silicon source gas includes at least one of monosilane, disilane, monochlorosilane, and dichlorosilane.

In some embodiments, the average particle size of the carbon matrix is 0.5 μm to 20 μm, which may specifically be 0.5 μm, 1 μm, 1.5 μm, 3 μm, 5 μm, 8 μm, 10.5 μm, 12 μm, 15 μm, 16 μm, 18 μm, or 20 μm, etc., or may be another value within the above range, which is not limited herein.

In some embodiments, the average pore diameter of the carbon matrix is Dnm, where 0.1≤D≤20, and the average pore diameter may specifically be 0.1 nm, 0.5 nm, 1 nm, 3 nm, 5 nm, 6.5 nm, 8.7 nm, 10 nm, 12.3 nm, 15 nm, 18 nm, or 20 nm, etc., or may be another value within the above range, which is not limited herein. It can be understood that controlling the average pore diameter of the carbon matrix within the above range is beneficial to controlling the particle size of the silicon material, reducing the situation that the size of the silicon material is too large, alleviating the volume expansion of the silicon material, and reducing the probability of pulverization and crushing of the anode material, thereby improving the cycling performance of the anode material.

In some embodiments, the volume concentration ratio of the silicon source gas is N, where 0.01≤N≤0.8, and the volume concentration ratio of the silicon source gas may specifically be 1%, 5%, 10%, 15%, 20%, 30%, 50%, 60%, 70%, 75%, or 80%, etc., but is not limited to the recited values, and other unrecited values within the numerical range are also applicable.

In some embodiments, the flow rate of the silicon source gas is V L/min, where 0.5≤V≤500, which may specifically be 0.5 L/min, 1 L/min, 5 L/min, 10 L/min, 50 L/min, 100 L/min, 150 L/min, 200 L/min, 300 L/min, 400 L/min, or 500 L/min, etc., or may be another value within the above range, which is not limited herein.

In some embodiments, the deposition time of the vapor deposition is t hours, where 0.5≤t≤20, which may specifically be 0.5 h, 1 h, 3 h, 5 h, 6 h, 8 h, 10 h, 12 h, 15 h, 18 h or 20 h, etc., which is not limited herein.

In some embodiments, the deposition temperature of the vapor deposition is T° C., where 300≤T≤800, which may specifically be 300° C., 350° C., 400° C., 500° C., 600° C., 650° C., 700° C., or 800° C., etc., or may be another value within the foregoing range, which is not limited herein. It can be understood that controlling the temperature of the vapor deposition within the above range is beneficial to controlling the crystal form of the silicon material, reducing the crystallinity of the silicon material, and reducing the conversion of amorphous silicon to crystalline silicon, thereby reducing the volume expansion of the anode material, and improving the cycling performance of the anode material.

In some embodiments, the method further includes: the active material is performed the carbon coating treatment to obtain an anode material with a carbon layer on the surface. The carbon coating treatment includes at least one of solid-phase carbon coating, liquid-phase carbon coating and gas-phase carbon coating.

It can be understood that, the carbon coating treatment is performed on the active material to form the carbon layer on the surface of the active material. On one hand, the direct contact between the anode material and the electrolyte can be reduced, and the occurrence of side reactions between the anode material and the electrolyte can be reduced, thereby improving the electrochemical performance of the anode material. On the other hand, the mechanical stress caused by the volume expansion of the anode material can also be alleviated, improving the structural stability of the anode material, and improving the interface stability, thereby improving the cycling performance of the anode material.

In some embodiments, the specific step of the carbon coating treatment includes: after the active material is heated, a protective gas and a carbon source gas are introduced, and the carbon source gas is thermally cracked to obtain the anode material with a carbon layer on the surface.

In some embodiments, the specific step of the carbon coating treatment includes: after the active material is heated, a protective gas and a carbon source gas are introduced, and the carbon source gas is thermally cracked to obtain the anode material with a carbon layer on the surface. The carbon source gas is a hydrocarbon.

In some embodiments, the specific step of the carbon coating treatment includes: after the active material is heated, a protective gas and a carbon source gas are introduced, and the carbon source gas is thermally cracked to obtain the anode material with a carbon layer on the surface. The carbon source gas includes at least one of methane, ethylene, acetylene, propyne, propylene, propane, toluene, benzene, styrene and phenol.

In some embodiments, the specific step of the carbon coating treatment includes: after the active material is heated, a protective gas and a carbon source gas are introduced, and the carbon source gas is thermally cracked to obtain the anode material with a carbon layer on the surface. The temperature of the thermal cracking is 600° C. to 1000° C., and the time of the thermal cracking is 30 minutes to 24 hours.

The temperature of the thermal cracking may specifically be 600° C., 620° C., 650° C., 680° C., 700° C., 760° C., 870° C., 900° C., 920° C., 950° C., 980° C., or 1000° C., etc., which is not limited herein. The time of the thermal cracking may specifically be 30 min, 1 h, 3 h, 5 h, 8 h, 12 h, 15 h, 18 h, 20 h, 22 h, or 24 h, etc., which is not limited herein.

In some embodiments, the specific step of the carbon coating treatment includes: the mixture obtained by mixing the active material and the solid-phase carbon source is carbonized to obtain the anode material with a carbon layer on the surface.

In some embodiments, the specific step of the carbon coating treatment includes: the mixture obtained by mixing the active material and the solid-phase carbon source is carbonized to obtain the anode material with a carbon layer on the surface. The temperature of the carbonization treatment is 500° C. to 1000° C., and the time of the carbonization treatment is 30 minutes to 24 hours.

The temperature of the carbonization treatment may specifically be 500° C., 540° C., 580° C., 600° C., 620° C., 650° C., 680° C., 700° C., 760° C., 870° C., 900° C., 920° C., 950° C., 980° C., or 1000° C., etc., which is not limited herein. The time of the carbonization treatment may specifically be 30 min, 1 h, 3 h, 5 h, 8 h, 12 h, 15 h, 18 h, 20 h, 22 h, or 24 h, etc., which is not limited herein.

In some embodiments, the specific step of the carbon coating treatment includes: the mixture obtained by mixing the active material and the solid-phase carbon source is carbonized to obtain the anode material with a carbon layer on the surface. The solid-phase carbon source includes at least one of sugars, esters, hydrocarbons, organic acids, and high molecular polymers.

In some embodiments, the specific step of the carbon coating treatment includes: the mixture obtained by mixing the active material and the solid-phase carbon source is carbonized to obtain the anode material with a carbon layer on the surface. The solid-phase carbon source includes at least one of polyvinyl chloride, polyvinyl butyral, polyacrylonitrile, polyacrylic acid, polyethylene glycol, polypyrrole, polyaniline, sucrose, glucose, maltose, citric acid, asphalt, furfuryl resin, epoxy resin and phenolic resin.

In some embodiments, the specific step of the carbon coating treatment includes: the mixture obtained by mixing the active material and the solid-phase carbon source is carbonized to obtain the anode material with a carbon layer on the surface. A mass ratio of the solid-phase carbon source to the anode material is (1-200):100, which may specifically be 1:100, 2:100, 5:100, 10:100, 50:100, 100:100, 150:100, 180:100, or 200:100, etc., which is not limited herein.

In some embodiments, the specific step of the carbon coating treatment includes: the mixture obtained by mixing the active material and the liquid-phase carbon source is carbonized to obtain the anode material with a carbon coating layer on the surface.

In some embodiments, the specific step of the carbon coating treatment includes: the mixture obtained by mixing the active material and the liquid-phase carbon source is carbonized to obtain the anode material with a carbon layer on the surface. A mass ratio of the liquid-phase carbon source to the anode material is (1-200):100, which may specifically be 1:100, 2:100, 5:100, 10:100, 50:100, 100:100, 150:100, 180:100, or 200:100, etc., which is not limited herein.

In some embodiments, the specific step of the carbon coating treatment includes: the mixture obtained by mixing the active material and the liquid-phase carbon source is carbonized to obtain the anode material with a carbon layer on the surface. The liquid-phase carbon source includes at least one of n-hexane, toluene, benzene, xylene, methanol, ethanol, propanol, butanol, pentanol, acetone, butanone, 2-pentanone, methyl acetate, ethyl acetate, propyl acetate, butyl acetate and amyl acetate.

In some embodiments, the specific step of the carbon coating treatment includes: the mixture obtained by mixing the active material and the liquid-phase carbon source is carbonized to obtain the anode material with a carbon layer on the surface. The temperature of the carbonization treatment is 600° C. to 1200° C., and the time of the carbonization treatment is 2 hours to 20 hours.

The temperature of the carbonization treatment may specifically be 600° C., 620° C., 650° C., 680° C., 700° C., 760° C., 870° C., 900° C., 920° C., 950° C., 980° C., 1000° C., 1020° C., 1080° C., 1100° C., 1160° C., or 1200° C., etc., which is not limited herein. The time of the carbonization treatment may specifically be 2 h, 3 h, 5 h, 8 h, 12 h, 15 h, 18 h, 20 h, 22 h, 24 h, 25 h, 26 h, 28 h, or 30 h, etc., which is not limited herein.

In some embodiments, the carbon coating treatment is performed under a protective atmosphere that includes at least one of nitrogen, helium, neon, argon, and krypton.

In some embodiments, the method further includes: the product of the carbon coating treatment is subjected to shaping, screening and grading to obtain the anode material with a carbon layer on the surface. The shaping process includes at least one of crushing, grinding, ball milling, and gas crushing.

According a fourth aspect, the present disclosure provides a preparation method of the anode material, including the following steps:

Step S100, the carbon matrix with pores is provided.

Step S200, the vapor deposition is performed on the carbon matrix using the silicon source gas to obtain the active material. The anode material includes the active material, the average particle size of the carbon matrix is D m, the average pore diameter of the carbon matrix is Vnm, the volume concentration ratio of the silicon source gas is H, the flow rate of the silicon source gas is NL/min, the deposition time of the vapor deposition is T hours, and the deposition relationship is controlled to satisfy T*D^{1/2}=α*V²*N*H, where α represents a deposition coefficient, and 0.1≤α≤1.

According to the preparation method of the anode material provided by the present disclosure, the silicon material are uniformly filled in the pores of the carbon matrix using a vapor deposition process to prepare the anode material. The deposition of the silicon material on the surface of the carbon matrix can be reduced by controlling deposition conditions, and the silicon material are effectively filled in the pores of the carbon matrix, improving the capacity of the anode material. Meanwhile, the size and shape of the silicon material can be controlled to ensure that the anode material not only can relieve volume expansion but also can maintain structural stability during cycling, reducing the collapse of the material structure caused by volume expansion of the anode material during the lithium intercalation and de-intercalation process, and effectively reducing the occurrence of side reactions between the anode material and the electrolyte, thereby improving the cycling performance of the anode material.

Step S100, the carbon matrix with pores is provided.

It should be noted that, the carbon matrix with pores in the present disclosure may be directly purchased and used, or may be prepared by carbonizing a carbon source, which is not limited herein.

In some embodiments, the step of providing the carbon matrix with pores includes: after the carbon source is carbonized, the product of the carbonization treatment is acidified and activated to obtain the carbon matrix with pores.

In some embodiments, the carbon source includes at least one of bamboo charcoal, coconut shells, resin, starch, and husks.

In some embodiments, the step of acidifying the product of the carbonization treatment includes: the product of the carbonization treatment is placed in an acid solution with a concentration of 0.5 mol/L to 15 mol/L for 0.5 hours to 20 hours.

The concentration of the acid solution may specifically be 0.5 mol/L, 1 mol/L, 3 mol/L, 5 mol/L, 7 mol/L, 9 mol/L, 10 mol/L, 12 mol/L, 14 mol/L, or 15 mol/L, etc., which is not limited herein.

The time for placing the product of the carbonization treatment in the acid solution may specifically be 0.5 h, 0.8 h, 1 h, 2 h, 3 h, 5 h, 8 h, 12 h, 15 h, 18 h, or 20 h, etc., which is not limited herein.

In some embodiments, the step of pickling the product of the carbonization treatment includes: the product of the carbonization treatment is placed in an acid solution with a concentration of 0.5 mol/L to 15 mol/L for 0.5 hours to 20 hours. The acid solution includes at least one of hydrochloric acid, nitric acid, sulfuric acid, carbonic acid, acetic acid, benzoic acid, hydrofluoric acid, oxalic acid, phosphoric acid and carboxylic acid.

In some embodiments, the step of activating the product of the carbonization treatment includes: the product of the carbonization treatment after acid pickling is dried and then placed in a mixed gas of nitrogen and water vapor for activation treatment. It can be understood that the acid pickling and activation treatment are conducive to the directional deposition of silicon material into the pores of the carbon matrix during the subsequent silicon deposition process, thereby reducing the deposition of silicon material on the surface of the carbon matrix.

In some embodiments, the step of activating the product of the carbonization treatment includes: the product of the carbonization treatment after acid pickling is dried and then placed in a mixed gas of nitrogen and water vapor for activation treatment. The concentration of the water vapor is 0.5% to 30%. The concentration of the water vapor may specifically be 0.5%, 1%, 3%, 5%, 8%, 10%, 12%, 15%, 18%, 20%, 22%, 25%, or 30%, etc., which is not limited herein.

In some embodiments, the step of activating the product of the carbonization treatment includes: the product of the carbonization treatment after acid pickling is dried and then placed in a mixed gas of nitrogen and water vapor for activation treatment. The temperature of the activation treatment is 380° C. to 2000° C., and the time of the activation treatment is 0.5 hours to 30 hours.

The temperature of the activation treatment may specifically be 380° C., 400° C., 500° C., 800° C., 1000° C., 1200° C., 1500° C., 1800° C., or 2000° C., etc., which is not limited herein. The time of the activation treatment may specifically be 0.5 h, 1 h, 3 h, 5 h, 8 h, 10 h, 12 h, 15 h, 18 h, 24 h, or 30 h, etc., which is not limited herein.

In some embodiments, the temperature of the carbonization treatment is 400° C. to 2000° C., and the time of the carbonization treatment is 3 hours to 30 hours.

The temperature of the carbonization treatment may specifically be 400° C., 500° C., 600° C., 800° C., 1000° C., 1200° C., 1500° C., 1800° C., or 2000° C., etc., which is not limited herein. The time of the carbonization treatment may specifically be 3 h, 5 h, 8 h, 12 h, 15 h, 18 h, 24 h, 28 h, or 30 h, etc., which is not limited herein.

Step S200, the vapor deposition is performed on the carbon matrix using the silicon source gas to obtain the active material. The anode material includes the active material, the average particle size of the carbon matrix is D m, the average pore diameter of the carbon matrix is Vnm, the volume concentration ratio of the silicon source gas is H, the flow rate of the silicon source gas is NL/min, the deposition time of the vapor deposition is T hours, and the deposition relationship is controlled to satisfy T*D^{1/2}=α*V²*N*H, where α represents a deposition coefficient, and 0.1≤α≤1.

A value of a may specifically be 0.1, 0.3, 0.5, 0.65, 0.7, 0.78, 0.89, 0.92, 0.98, or 1, etc., which is not limited herein.

In some embodiments, the silicon source gas includes at least one of methylsilane, ethylsilane, monochlorosilane, and dichlorosilane.

In some embodiments, the average particle size of the carbon matrix is 1 μm to 15 μm, which may specifically be 1 μm, 3 μm, 5 μm, 8 μm, 10 μm, 11 μm, 12 μm, 13 μm, 14 μm, or 15 μm, etc., or may be another value within the above range, which is not limited herein.

In some embodiments, the average pore diameter of the carbon matrix is 0.1 nm to 5 nm, which may specifically be 0.1 nm, 0.5 nm, 1 nm, 1.5 nm, 2 nm, 3 nm, 3.7 nm, 4 nm, 4.5 nm, 4.8 nm, or 5 nm, etc., but is not limited to the recited values, and other unrecited values within the numerical range are also applicable.

In some embodiments, the volume concentration ratio of the silicon source gas is 1% to 90%, which may specifically be 1%, 5%, 10%, 15%, 20%, 30%, 40%, 50%, 60%, 70%, 80%, or 90%, etc., or may be another value within the above range, which is not limited herein.

In some embodiments, the flow rate of the silicon source gas is 0.5 L/min to 100 L/min, which may specifically be 0.5 L/min, 1 L/min, 5 L/min, 10 L/min, 20 L/min, 30 L/min, 50 L/min, 70 L/min, 85 L/min, 95 L/min, or 100 L/min, etc., or may be another value within the above range, which is not limited herein.

In some embodiments, the deposition time of the vapor deposition is 0.1 h to 15 h, which may specifically be 0.1 h, 0.5 h, 1 h, 3 h, 5 h, 8 h, 10 h, 12 h, 13 h, 14 h, or 15 h, etc., which is not limited herein.

In some embodiments, the deposition temperature of the vapor deposition is 300° C. to 800° C., which may specifically be 300° C., 400° C., 500° C., 600° C., 650° C., 700° C., 750° C., or 800° C., etc., but is not limited to the recited values, and other unrecited values within the numerical range are also applicable.

In some embodiments, the method further includes: the active material is performed the carbon coating treatment to obtain an anode material with a carbon layer on the surface. The carbon coating treatment includes at least one of solid-phase carbon coating, liquid-phase carbon coating and gas-phase carbon coating.

In some embodiments, the specific step of the carbon coating treatment includes: after the active material is heated, a protective gas and a carbon source gas are introduced, and the carbon source gas is thermally cracked to obtain the anode material with a carbon layer on the surface.

In some embodiments, the specific step of the carbon coating treatment includes: after the active material is heated, a protective gas and a carbon source gas are introduced, and the carbon source gas is thermally cracked to obtain the anode material with a carbon layer on the surface. The carbon source gas is a hydrocarbon.

In some embodiments, the specific step of the carbon coating treatment includes: after the active material is heated, a protective gas and a carbon source gas are introduced, and the carbon source gas is thermally cracked to obtain the anode material with a carbon layer on the surface. The carbon source gas includes at least one of methane, ethylene, acetylene, propyne, propylene, propane, toluene, benzene, styrene and phenol.

In some embodiments, the specific step of the carbon coating treatment includes: after the active material is heated, a protective gas and a carbon source gas are introduced, and the carbon source gas is thermally cracked to obtain the anode material with a carbon layer on the surface. The temperature of the thermal cracking is 600° C. to 1000° C., and the time of the thermal cracking is 30 minutes to 24 hours.

The temperature of thermal cracking may specifically be 600° C., 650° C., 680° C., 700° C., 780° C., 800° C., 900° C., 960° C. or 1000° C., etc., and the time of thermal cracking may specifically be 30 min, 1 h, 3 h, 5 h, 8 h, 10 h, 12 h, 15 h, 18 h, or 24 h, etc., which is not limited herein.

In some embodiments, the specific step of the carbon coating treatment includes: the mixture obtained by mixing the active material and the solid-phase carbon source is carbonized to obtain the anode material with a carbon layer on the surface.

In some embodiments, the specific step of the carbon coating treatment includes: the mixture obtained by mixing the active material and the solid-phase carbon source is carbonized to obtain the anode material with a carbon layer on the surface. The temperature of the carbonization treatment is 500° C. to 1000° C., and the time of the carbonization treatment is 30 minutes to 24 hours.

The temperature of the carbonization treatment may specifically be 600° C., 650° C., 680° C., 700° C., 780° C., 800° C., 900° C., 960° C., or 1000° C., etc., which is not limited herein. The time of the carbonization treatment may specifically be 30 min, 1 h, 3 h, 5 h, 8 h, 10 h, 12 h, 15 h, 18 h, or 24 h, etc., which is not limited herein.

In some embodiments, the specific step of the carbon coating treatment includes: the mixture obtained by mixing the active material and the solid-phase carbon source is carbonized to obtain the anode material with a carbon layer on the surface. The solid-phase carbon source includes at least one of sugars, esters, hydrocarbons, organic acids, and high molecular polymers.

In some embodiments, the specific step of the carbon coating treatment includes: the mixture obtained by mixing the active material and the solid-phase carbon source is carbonized to obtain the anode material with a carbon layer on the surface. The solid-phase carbon source includes at least one of polyvinyl chloride, polyvinyl butyral, polyacrylonitrile, polyacrylic acid, polyethylene glycol, polypyrrole, polyaniline, sucrose, glucose, maltose, citric acid, asphalt, furfuryl resin, epoxy resin and phenolic resin.

In some embodiments, the specific step of the carbon coating treatment includes: the mixture obtained by mixing the active material and the solid-phase carbon source is carbonized to obtain the anode material with a carbon layer on the surface. The mass ratio of the solid-phase carbon source to the active material is (1-50):(20-100), which may specifically be 1:99, 10:90, 20:80, 30:70, or 50:50, etc., which is not limited herein.

In some embodiments, the specific step of the carbon coating treatment includes: the mixture obtained by mixing the active material and the liquid-phase carbon source is carbonized to obtain the anode material with a carbon coating layer on the surface.

In some embodiments, the specific step of the carbon coating treatment includes: the mixture obtained by mixing the active material and the liquid-phase carbon source is carbonized to obtain the anode material with a carbon layer on the surface. The mass ratio of the liquid-phase carbon source to the active material is (1-50):(20-100), which may specifically be 1:99, 10:90, 20:80, 30:70, or 50:50, etc., which is not limited herein.

In some embodiments, the specific step of the carbon coating treatment includes: the mixture obtained by mixing the active material and the liquid-phase carbon source is carbonized to obtain the anode material with a carbon layer on the surface. The liquid-phase carbon source includes at least one of n-hexane, toluene, benzene, xylene, methanol, ethanol, propanol, butanol, pentanol, acetone, butanone, 2-pentanone, methyl acetate, ethyl acetate, propyl acetate, butyl acetate and amyl acetate.

In some embodiments, the specific step of the carbon coating treatment includes: the mixture obtained by mixing the active material and the liquid-phase carbon source is carbonized to obtain the anode material with a carbon layer on the surface. The temperature of the carbonization treatment is 600° C. to 1200° C., and the time of the carbonization treatment is 2 hours to 20 hours.

The temperature of the carbonization treatment may specifically be 600° C., 650° C., 700° C., 800° C., 900° C., 1000° C., or 1200° C., etc., which is not limited herein.

The time of the carbonization treatment may specifically be 2 h, 5 h, 8 h, 10 h, 12 h, 15 h, 18 h, or 20 h, etc., which is not limited herein.

In some embodiments, the carbon coating treatment is performed under a protective atmosphere that includes at least one of nitrogen, helium, neon, argon, and krypton.

In some embodiments, the method further includes: the product of the carbon coating treatment is subjected to shaping, screening and grading to obtain the anode material with a carbon layer on the surface. The shaping process includes at least one of crushing, grinding, ball milling, and gas crushing.

According to a fifth aspect, the present disclosure provides a lithium ion battery. The lithium ion battery includes the anode material according to the first aspect or the anode material prepared by the preparation method of the anode material according to the second aspect.

The anode material of the first aspect and the anode material of the second aspect of the present disclosure are further described below in various examples and comparative examples. The examples of the present disclosure are not limited to the following specific examples. Variations may be made as appropriate within the scope of the independent claims.

### Test Methods:

(1) Method for testing the specific surface area of the anode material:

The specific surface area was measured using an American Micrometrics TriStar 3000 BET surface area and pore size analyzer.

(2) Method for testing the total pore volume of the anode material or the carbon matrix:

The pore volume V was measured using a Micrometrics ASAP 2460 analyzer, and calculated in a pore diameter range of 17 Å to 3000 Å using a BJH Desortation cumulative volume of pores model.

Microporous and mesoporous analysis were performed using Micromeritics ASAP 2460. At liquid nitrogen temperatures, the equilibrium adsorption amount of nitrogen on the surface of an object was related to its pore diameter and other characteristics. Combined with the pattern of adsorption as the adsorption amount changed with relative pressure, various models were fitted to calculate the pore diameter. The report generated by the software used a density functional theory (DFT) method to calculate the pore diameter distribution, total pore volume, and pore volume in specific ranges.

(3) Method for testing the pore diameter of the anode material or the carbon matrix:

An appropriate amount of sample particles were taken and measured using a transmission electron microscope (TEM) to determine the pore diameter and porosity of the pores.

(4) Method for testing the particle size of the silicon material:

Silicon nano-particles were observed using a field emission scanning electron microscope or a transmission electron microscope, and the particle sizes of 5-10 silicon nano-particles were directly measured using a scale. The average value of the particle sizes was taken as the final particle size of the silicon nano-particles.

(5) Method for testing the particle size of the anode material:

The particle size distribution was measured using a Malvern laser particle size analyzer MS3000. The intensity of scattered light at different angles depends on the size of the particles, with larger particles scattering at smaller angles and smaller particles scattering at larger angles. By utilizing laser diffraction and the intensity distribution, the particle size distribution was obtained.

(6) Calculation method for half-peak width

The half-peak width (FWHM) was defined as FWHM=2[(Xp−Xl)+(XP−Xr)], where Xp represents the position of the peak top of the curve, and Xl and Xr represent the peak values corresponding to the curve ranges, respectively (for example, 200 mV-350 mV corresponds to peak strengths at 200 mV and 350 mV).

(7) Electrochemical performance test:

The electrochemical cycling performance was tested as follows: the anode material prepared in Examples 1 to 8 and Comparative Examples 1 to 3, along with a conductive agent and a binder, were dissolved in a solvent at a mass percentage of 94:1:5, and the solid content was controlled to be 50%. This mixture was coated on a copper foil current collector, vacuum-dried, and prepared into an anode pole piece. A ternary positive electrode pole piece prepared by a conventional mature process, 1 mol/L lithium hexafluorophosphate LiPF6/(ethylene carbonate EC+dimethyl carbonate DMC+ethyl methyl carbonate EMC) (v/v=1:1:1) electrolyte, a Celgard2400 separator and a shell were assembled into an 18650-cylinder single battery by a conventional production process. The charging and discharging test of the cylindrical battery was conducted on a LAND battery test system of Wuhan Kono Electronics Co., Ltd., under normal temperature condition. The constant current charge and discharge rate was 0.2 C, with voltage limits set between 2.75V and 4.2V A first reversible capacity, a first cycle charge capacity, and a first cycle discharge capacity were obtained. The first Coulombic efficiency was calculated as the ratio of the first cycle discharge capacity to the first cycle charge capacity.

After the cycling was repeated for 50 times, a thickness H1 of the pole piece of the lithium ion battery was measured using a micrometer, and the expansion rate after 50 cycles was calculated as (H1−H0)/H0×100%.

After the cycling was repeated for 50 times, the discharge capacity was recorded as the remaining capacity of the lithium ion battery, and the capacity retention was calculated as the remaining capacity/the initial capacity×100%.

Performance Test of the Anode material of the First Aspect:

### Example 1

(1) The husks were carbonized at 500° C. for 5 hours. The product of the carbonization treatment was then acid-washed with 5 mol/L hydrochloric acid for 4 hours. After drying, the product was placed in a heat treatment furnace where a mixed gas of water vapor and nitrogen (volume ratio 1:80) was introduced for activation at 800° C. for 12 hours to obtain a carbon matrix with an average pore diameter of 2.1 nm.

(2) The carbon matrix was placed in chemical vapor deposition (CVD) device, and silane was introduced into the CVD device at a rate of 18 L/min. The volume concentration ratio of the silane was controlled at 20%. The temperature was then raised to 500° C., and a vapor deposition reaction was performed for 4 hours to obtain the active material.

(3) The active material was mixed with the phenolic resin at a mass ratio of 50:15. The mixture was then placed in a high-temperature box furnace, and nitrogen was introduced. The mixture was performed the heat treatment at 720° C. for 2 hours.

(4) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 2.3 nm. The specific surface area of the anode material is 2.9 m²/g, and the median particle size of the anode material is 10 μm.

In this example, the K value of the vapor deposition is 3.35.

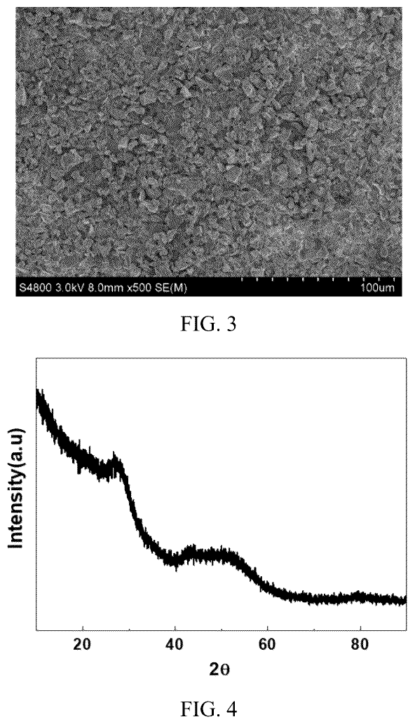

FIG. 3 shows a scanning electron microscope (SEM) image of an anode material prepared in Example 1 of the present disclosure.

FIG. 4 shows an XRD pattern of the anode material prepared in Example 1 of the present disclosure. As shown in FIG. 4, the silicon material in the anode material are in an amorphous state.

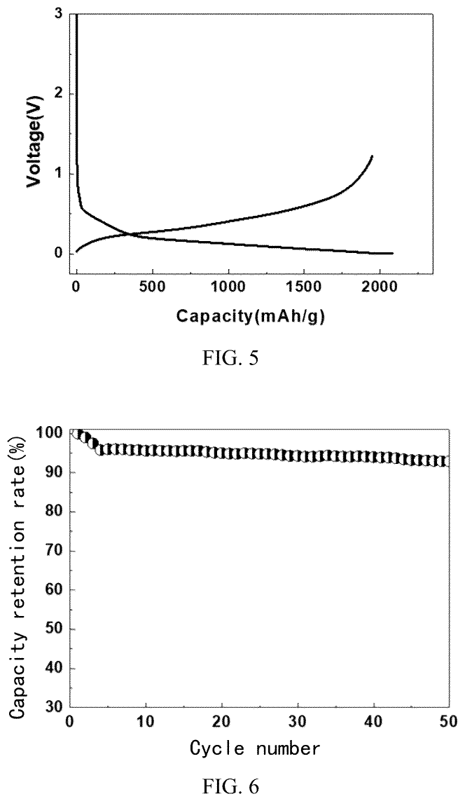

FIG. 5 shows a first charge-discharge curve of the anode material prepared in Example 1 of the present disclosure. As shown in FIG. 5, the first charge and discharge capacity of the anode material is 1955 mAh/g, and the first efficiency is 92.9%.

FIG. 6 shows a cycling performance curve of the anode material prepared in Example 1 of the present disclosure. As shown in FIG. 6, the anode material has excellent cycling performance, with the capacity retention rate of 92.6% after 50 cycles.

### Example 2

(1) A commercial carbon matrix with an average pore diameter of 1.6 nm was placed in chemical vapor deposition (CVD) device, and silane was introduced into the CVD device at a rate of 19 L/min. The volume concentration ratio of the silane was controlled at 40%. The temperature was then raised to 600° C., and a vapor deposition reaction was performed for 3 hours to obtain the active material.

(2) The active material was mixed with the sucrose at a mass ratio of 50:45. The mixture was then placed in a high-temperature box furnace, and nitrogen was introduced. The mixture was performed the heat treatment at 620° C. for 2 hours.

(3) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 1.8 nm. The specific surface area of the anode material is 3.4 m²/g, and the median particle size of the anode material is 8.2 μm.

In this example, the K value of the vapor deposition is 4.47.

### Example 3

(1) The starch was carbonized at 600° C. for 8 hours. The product of the carbonization treatment was then acid-washed with 3 mol/L hydrochloric acid for 7 hours. After drying, the product was placed in a heat treatment furnace where a mixed gas of water vapor and nitrogen (volume ratio 3:80) was introduced for activation at 900° C. for 12 hours to obtain a carbon matrix with an average pore diameter of 1.8 nm.

(2) The carbon matrix was placed in chemical vapor deposition (CVD) device, and silane was introduced into the CVD device at a rate of 16 L/min. The volume concentration ratio of the silane was controlled at 25%. The temperature was then raised to 700° C., and a vapor deposition reaction was performed for 2.5 hours to obtain the active material.

(3) The active material was mixed with the epoxy resin at a mass ratio of 50:45. The mixture was then placed in a high-temperature box furnace, and nitrogen was introduced. The mixture was performed the heat treatment at 650° C. for 2 hours.

(4) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 2.0 nm. The specific surface area of the anode material is 3.8 m²/g, and the median particle size of the anode material is 5.9 μm.

In this example, the K value of the vapor deposition is 3.22.

### Example 4

(1) A commercial carbon matrix with an average pore diameter of 1.3 nm was placed in chemical vapor deposition (CVD) device, and silane was introduced into the CVD device at a rate of 21 L/min. The volume concentration ratio of the silane was controlled at 50%. The temperature was then raised to 500° C., and a vapor deposition reaction was performed for 4 hours to obtain the active material.

(2) The active material was mixed with the phenolic resin at a mass ratio of 30:45. The mixture was then placed in a high-temperature box furnace, and nitrogen was introduced. The mixture was performed the heat treatment at 820° C. for 4 hours.

(3) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 1.6 nm. The specific surface area of the anode material is 2.4 m²/g, and the median particle size of the anode material is 7.4 μm.

In this example, the K value of the vapor deposition is 2.71.

### Example 5

Different from Example 4:

(1) A commercial carbon matrix with an average pore diameter of 1.3 nm was placed in chemical vapor deposition (CVD) device, and silane was introduced into the CVD device at a rate of 21 L/min. The volume concentration ratio of the silane was controlled at 80%. The temperature was then raised to 500° C., and a vapor deposition reaction was performed for 4 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 3.5 nm. The specific surface area of the anode material is 2.1 m²/g, and the median particle size of the anode material is 8.2 μm.

In this example, the K value of the vapor deposition is 4.3.

### Example 6

Different from Example 4:

(1) A commercial carbon matrix with an average pore diameter of 1.3 nm was placed in chemical vapor deposition (CVD) device, and silane was introduced into the CVD device at a rate of 100 L/min. The volume concentration ratio of the silane was controlled at 5%. The temperature was then raised to 500° C., and a vapor deposition reaction was performed for 6 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 3.5 nm. The specific surface area of the anode material is 2.1 m²/g, and the median particle size of the anode material is 8.2 μm.

In this example, the K value of the vapor deposition is 2.73.

### Example 7

Different from Example 1:

(2) The carbon matrix was placed in chemical vapor deposition (CVD) device, and silane was introduced into the CVD device at a rate of 18 L/min. The volume concentration ratio of the silane was controlled at 20%. The temperature was then raised to 800° C., and a vapor deposition reaction was performed for 4 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 5.5 nm. The specific surface area of the anode material is 2.8 m²/g, and the median particle size of the anode material is 9.8 μm.

In this example, the K value of the vapor deposition is 1.66.

### Example 8

Different from Example 1:

(2) The carbon matrix was placed in chemical vapor deposition (CVD) device, and silane was introduced into the CVD device at a rate of 18 L/min. The volume concentration ratio of the silane was controlled at 20%. The temperature was then raised to 600° C., and a vapor deposition reaction was performed for 6 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 5.5 nm. The specific surface area of the anode material is 2.8 m²/g, and the median particle size of the anode material is 9.8 μm.

In this example, the K value of the vapor deposition is 1.1.

### Comparative Example 1

Different from Example 1 in that:

(2) The carbon matrix was placed in chemical vapor deposition (CVD) device, and silane was introduced into the CVD device at a rate of 34 L/min. The volume concentration ratio of the silane was controlled at 22%. The temperature was then raised to 500° C., and a vapor deposition reaction was performed for 4 hours to obtain the active material.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 5.3 nm. The specific surface area of the anode material is 3.1 m²/g, and the median particle size of the anode material is 9.7 μm.

In this example, the K value of the vapor deposition is 13.16.

### Comparative Example 2

Different from Example 1:

(1) The husks were carbonized at 500° C. for 5 hours. The product of the carbonization treatment was then acid-washed with 5 mol/L hydrochloric acid for 4 hours. After drying, the product was placed in a heat treatment furnace where a mixed gas of water vapor and nitrogen (volume ratio 5:80) was introduced for activation at 1500° C. for 12 hours to obtain a carbon matrix with an average pore diameter of 4.5 nm.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 4.9 nm. The specific surface area of the anode material is 2.9 m²/g, and the median particle size of the anode material is 10.3 μm.

In this example, the K value of the vapor deposition is 33.

### Comparative Example 3

Different from Example 1:

(2) The carbon matrix was placed in chemical vapor deposition (CVD) device, and silane was introduced into the CVD device at a rate of 18 L/min. The volume concentration ratio of the silane was controlled at 20%. The temperature was then raised to 900° C., and a vapor deposition reaction was performed for 5 hours to obtain the active material.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the average particle size of the silicon material is 5.4 nm. The specific surface area of the anode material is 3.3 m²/g, and the median particle size of the anode material is 9.8 μm.

In this example, the K value of the vapor deposition is 0.89.

The anode material prepared in Example 1 to Example 8 is the anode material provided in the first aspect of the present disclosure, and the preparation method thereof adopts the preparation method provided in the third aspect of the present disclosure. The test results of the above Examples 1-8 and Comparative Examples 1-3 are shown in Table 1 below.

TABLE 1
Performance test results of the anode materials in Examples 1-8 and
Comparative Examples 1-3

| | | | | | First | First | 50-Week | 50-Cycle |
|---|---|---|---|---|---|---|---|---|
| | | | | | Reversible | Coulombic | Pole Piece | Capacity |
| | K | A1 | B1 | | Capacity | Efficiency | Expansion | Retention |
| | Value | Value | Value | B1/A1 | (mAh/g) | (%) | Rate (%) | Rate (%) |
| Example 1 | 3.35 | 12200 | 19050 | 1.56 | 1955 | 92.9 | 35.2 | 92.6 |
| Example 2 | 4.47 | 11800 | 37850 | 3.2 | 1901 | 92.7 | 34.0 | 92.9 |
| Example 3 | 3.22 | 13500 | 14650 | 1.08 | 2001 | 92.9 | 34.3 | 92.8 |
| Example 4 | 2.71 | 10500 | 25500 | 2.42 | 2033 | 92.8 | 32.8 | 93.1 |
| Example 5 | 4.3 | 11700 | 43200 | 3.69 | 2067 | 93.2 | 37.2 | 91.9 |
| Example 6 | 2.73 | 12040 | 26820 | 2.23 | 2014 | 92.5 | 31.9 | 93.0 |
| Example 7 | 1.66 | 13345 | 52302 | 3.92 | 1995 | 92.5 | 34.9 | 92.0 |
| Example 8 | 1.1 | 11389 | 20997 | 1.84 | 2005 | 92.7 | 33.8 | 92.2 |
| Comparative | 13.16 | 14500 | 75500 | 5.20 | 1899 | 91.0 | 43.2 | 88.9 |
| Example 1 | | | | | | | | |
| Comparative | 33 | 17200 | 89050 | 5.17 | 1950 | 90.1 | 44.3 | 88.1 |
| Example 2 | | | | | | | | |
| Comparative | 0.89 | 15200 | 99050 | 6.51 | 1998 | 90.9 | 45.9 | 87.9 |
| Example 3 | | | | | | | | |

According to the data in Table 1, the anode material prepared in Examples 1 to 8 are prepared by fully filling the silicon material in the pores of the carbon matrix using the vapor deposition process. The deposition of the silicon material on the surface of the carbon matrix can be reduced by controlling deposition conditions, and the silicon material are effectively filled in the pores of the carbon matrix, improving the capacity of the anode material. Meanwhile, the size and shape of the silicon material can be controlled to ensure that the anode material not only can relieve volume expansion but also can maintain structural stability during cycling, reducing the collapse of the material structure caused by volume expansion of the anode material during the lithium intercalation and de-intercalation process, and effectively reducing the occurrence of side reactions between the anode material and the electrolyte, thereby improving the cycling performance of the anode material.

According to the test data of Example 1 and Comparative Example 1 in Table 1, it can be seen that, in the preparation process of the anode material of Comparative Example 1, the flow rate V of the silane introduced during the vapor deposition process is relatively high. The loading amount of the silane gas introduced over the same time increase, leading to an increased deposition of silicon material in the pores of the carbon matrix, resulting in the silicon material growing larger, which ultimately causes the particle size of the silicon material in the pores of the carbon matrix to be larger. As a result, the B1 value of the anode material increases, and the B1/A1 ratio deviates from the above range. During cycling, the large particle size of the silicon material leads to a significant increase in the volume expansion of the anode material, so that the material is pulverized and crushed, and the side reactions between the anode material and the electrolyte is exacerbated, thereby leading to a reduction in the capacity, the first coulombic efficiency and the cycling performance of the anode material.

According to the test data of Example 1 and Comparative Example 2 in Table 1, it can be seen that, in the preparation process of the anode material of Comparative Example 2, the average pore diameter of the porous carbon material is relatively large, resulting in a larger particle size of silicon material deposited in the pores of the carbon matrix. As a result, the B1 value of the anode material increases, and the B1/A1 ratio deviates from the above range. During cycling, the large particle size of the silicon material leads to a significant increase in the volume expansion of the anode material, so that the material is pulverized and crushed, and the side reactions between the anode material and the electrolyte is exacerbated, thereby leading to a reduction in the capacity, the first coulombic efficiency and the cycling performance of the anode material.

According to the test data of Example 1 and Comparative Example 3 in Table 1, it can be seen that, in the preparation process of the anode material of Comparative Example 3, the temperature during the vapor deposition is too high, which causes the silicon material to undergo secondary growth, resulting in the formation of larger silicon material. Additionally, the silicon material may be converted from amorphous silicon to crystalline silicon at a high temperature. The lithium intercalation peak position of the crystalline silicon is enhanced, meaning the peak value of the anode material at A1 is enhanced, but at the same time, the peak value of the anode material at B1 becomes even stronger. As a result, the B1/A1 ratio increases, and the B1/A1 ratio deviates from the above range. The increased volume expansion of the anode material leads to the pulverization and crushing of the material, which exacerbates the side reactions between the material and the electrolyte, thereby leading to a reduction in the capacity, the first coulombic efficiency and the cycling performance of the anode material.

### Performance Test of the Anode Material of the Second Aspect:

### Example 9

(1) The bamboo charcoal was carbonized at 800° C. for 16 hours. The product of the carbonization treatment was then treated with 6 mol/L hydrochloric acid for 5 hours. After drying, a mixed gas of water vapor and nitrogen (the concentration of the water vapor was 7.8%) was introduced. The product was heated to 780° C. and activated for 24 hours to obtain a carbon matrix with an average pore diameter of 2.1 nm and an average particle size of 10 μm.

(2) The carbon matrix was placed in chemical vapor deposition (CVD) device, and silane was introduced into the CVD device at a rate of 22 L/min. The volume concentration ratio of the silane was controlled at 50%. The temperature was then raised to 600° C., and a vapor deposition reaction was performed for 4 hours to obtain the active material.

(3) The active material was mixed with the phenolic resin at a mass ratio of 50:15. The mixture was then placed in a high-temperature box furnace, and nitrogen was introduced. The mixture was performed the heat treatment at 720° C. for 2 hours.

(4) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of amorphous silicon. The average particle size of the silicon material is 2.3 nm, the specific surface area of the anode material is 3.4 m²/g, and the median particle size of the anode material is 9.8 μm.

In this example, a deposition coefficient α of the vapor deposition is 0.26.

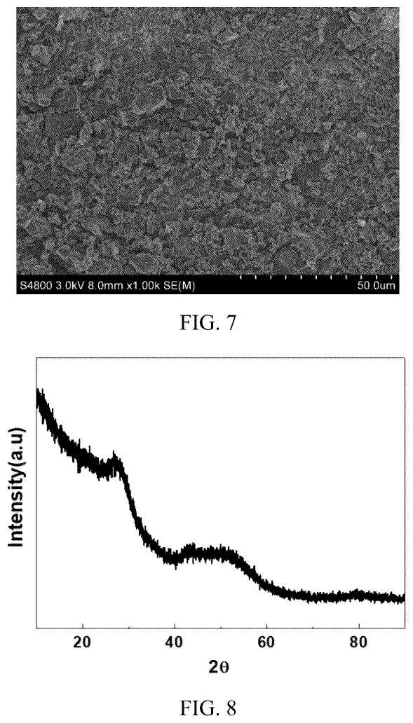

FIG. 7 shows a scanning electron microscope (SEM) image of an anode material prepared in Example 9 of the present disclosure.

FIG. 8 shows an XRD pattern of the anode material prepared in Example 9 of the present disclosure. As shown in FIG. 8, the silicon material in the anode material are in an amorphous state.

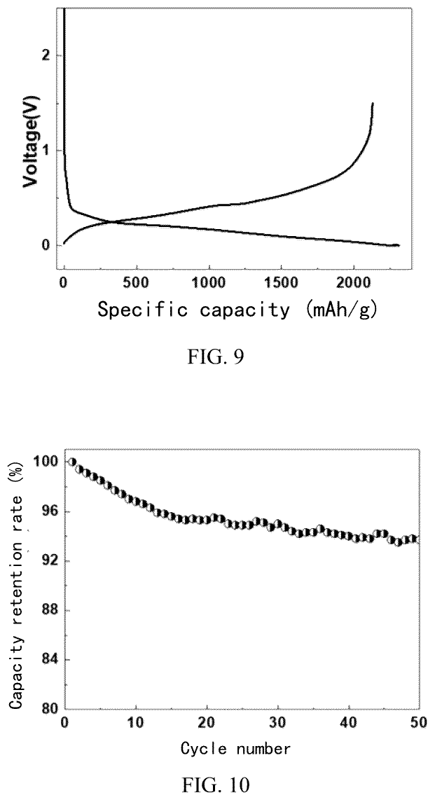

FIG. 9 shows a first charge-discharge curve of the anode material prepared in Example 9 of the present disclosure. As shown in FIG. 9, the first charge and discharge capacity of the anode material is as high as 2098 mAh/g, and the first efficiency is also as high as 93.1%.

FIG. 10 shows a cycling performance curve of the anode material prepared by Example 9 of the present disclosure. As shown in FIG. 10, the anode material has excellent cycling performance, with the capacity retention rate of 92.2% after 50 cycles.

### Example 10

(1) A commercial carbon matrix with an average pore diameter of 1.9 nm and an average particle size of 4 μm was placed in chemical vapor deposition (CVD) device, and silane was introduced into the CVD device at a rate of 9 L/min. The volume concentration ratio of the silane was controlled at 60%. The temperature was then raised to 680° C., and a vapor deposition reaction was performed for 5 hours to obtain the active material.

(2) The active material was mixed with the sucrose at a mass ratio of 50:45. The mixture was then placed in a high-temperature box furnace, and nitrogen was introduced. The mixture was performed the heat treatment at 920° C. for 2 hours.

(3) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of silicon material. The average particle size of the silicon material is 3.0 nm, the specific surface area of the anode material is 3.1 m²/g, and the median particle size of the anode material is 5.5 μm.

In this example, a deposition coefficient α of the vapor deposition is 0.51.

### Example 11

(1) The starch was carbonized at 950° C. for 8 hours. The product of the carbonization treatment was then treated with 4.6 mol/L hydrochloric acid for 7 hours. After drying, a mixed gas of water vapor and nitrogen (the concentration of the water vapor was 12.6%) was introduced. The product was heated to 980° C. and activated for 24 hours to obtain a carbon matrix with an average pore diameter of 1.5 nm and an average particle size of 6 μm.

(2) The carbon matrix was placed in chemical vapor deposition (CVD) device, and silane was introduced into the CVD device at a rate of 29 L/min. The volume concentration ratio of the silane was controlled at 45%. The temperature was then raised to 700° C., and a vapor deposition reaction was performed for 3 hours to obtain the active material.

(3) The active material was mixed with the epoxy resin at a mass ratio of 50:55. The mixture was then placed in a high-temperature box furnace, and nitrogen was introduced. The mixture was performed the heat treatment at 620° C. for 2 hours.

(4) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of amorphous silicon. The average particle size of the silicon material is 6.7 nm, the specific surface area of the anode material is 2.3 m²/g, and the median particle size of the anode material is 6.8 μm.

In this example, a deposition coefficient α of the vapor deposition is 0.25.

### Example 12

(1) A commercial carbon matrix with an average pore diameter of 3.6 nm and an average particle size of 14 μm was placed in chemical vapor deposition (CVD) device, and silane was introduced into the CVD device at a rate of 15 L/min. The volume concentration ratio of the silane was controlled at 65%. The temperature was then raised to 700° C., and a vapor deposition reaction was performed for 4 hours to obtain the active material.

(2) The active material was mixed with the phenolic resin at a mass ratio of 30:45. The mixture was then placed in a high-temperature box furnace, and nitrogen was introduced. The mixture was performed the heat treatment at 820° C. for 4 hours.

(4) The obtained sample was crushed, screened and then graded to obtain the anode material with a carbon layer on the surface.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 1.9 nm, the specific surface area of the anode material is 2.9 m²/g, and the median particle size of the anode material is 9.9 μm.

In this example, a deposition coefficient α of the vapor deposition is 0.12.

### Example 13

Different from Example 9:

(2) The carbon matrix was placed in chemical vapor deposition (CVD) device, and silane was introduced into the CVD device at a rate of 22 L/min. The concentration of the silane was controlled at 50%. The temperature was then raised to 600° C., and a vapor deposition reaction was performed for 6 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of amorphous silicon. The average particle size of the silicon material is 2.2 nm, the specific surface area of the anode material is 2.9 m²/g, and the median particle size of the anode material is 10.0 μm.

In this example, a deposition coefficient α of the vapor deposition is 0.39.

### Example 14

Different from Example 9:

(2) The carbon matrix was placed in chemical vapor deposition (CVD) device, and silane was introduced into the CVD device at a rate of 22 L/min. The concentration of the silane was controlled at 13%. The temperature was then raised to 600° C., and a vapor deposition reaction was performed for 4 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of amorphous silicon. The average particle size of the silicon material is 2.3 nm, the specific surface area of the anode material is 3.2 m²/g, and the median particle size of the anode material is 9.8 μm.

In this example, a deposition coefficient α of the vapor deposition is 1.0.

### Example 15

Different from Example 12:

(1) A commercial carbon matrix with an average pore diameter of 3.6 nm and an average particle size of 14 μm was placed in chemical vapor deposition (CVD) device, and silane was introduced into the CVD device at a rate of 15 L/min. The concentration of the silane was controlled at 10%. The temperature was then raised to 700° C., and a vapor deposition reaction was performed for 4 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 3.9 nm, the specific surface area of the anode material is 3.0 μm²/g, and the median particle size of the anode material is 9.6 μm.

In this example, a deposition coefficient α of the vapor deposition is 0.77.

### Example 16

Different from Example 12:

(1) A commercial carbon matrix with an average pore diameter of 3.6 nm and an average particle size of 14 μm was placed in chemical vapor deposition (CVD) device, and silane was introduced into the CVD device at a rate of 17 L/min. The concentration of the silane was controlled at 10%. The temperature was then raised to 700° C., and a vapor deposition reaction was performed for 4 hours to obtain the active material.

The anode material prepared in this example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 3.84 nm, the specific surface area of the anode material is 2.8 m²/g, and the median particle size of the anode material is 8.8 μm.

In this example, a deposition coefficient α of the vapor deposition is 0.10.

### Comparative Example 4

Different from Example 9:

(2) The carbon matrix was placed in chemical vapor deposition (CVD) device, and silane was introduced into the CVD device at a rate of 22 L/min. The concentration of the silane was controlled at 50%. The temperature was then raised to 600° C., and a vapor deposition reaction was performed for 16 hours to obtain the active material.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 3.9 nm, the specific surface area of the anode material is 4.4 m²/g, and the median particle size of the anode material is 9.4 μm.

In this example, a deposition coefficient α of the vapor deposition is 1.04.

### Comparative Example 5

Different from Example 9:

(1) The bamboo charcoal was carbonized at 850° C. for 16 hours. The product of the carbonization treatment was then treated with 6 mol/L hydrochloric acid for 5 hours. After drying, a mixed gas of water vapor and nitrogen (the concentration of the water vapor was 3.8%) was introduced. The product was heated to 720° C. and activated for 16 hours to obtain a carbon matrix with an average pore diameter of 5.8 nm and an average particle size of 10 μm.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 6.9 nm, the specific surface area of the anode material is 2.3 m²/g, and the median particle size of the anode material is 10.7 μm.

In this example, a deposition coefficient α of the vapor deposition is 0.03.

### Comparative Example 6

Different from Example 9:

(2) The porous carbon matrix was placed in chemical vapor deposition (CVD) device, and silane was introduced into the CVD device at a rate of 22 L/min. The concentration of the silane was controlled at 50%. The temperature was then raised to 850° C., and a vapor deposition reaction was performed for 16 hours to obtain the anode material.

The anode material prepared in this comparative example includes an active material that includes a carbon matrix and silicon material. The carbon matrix has pores, and at least part of the silicon material are distributed in the pores of the carbon matrix. The carbon matrix is made of porous carbon, and the silicon material are made of nano-silicon. The average particle size of the silicon material is 3.8 nm, the specific surface area of the anode material is 3.3 m²/g, and the median particle size of the anode material is 10.3 μm.

In this example, a deposition coefficient α of the vapor deposition is 1.04.

The anode material prepared in Example 9 to Example 16 is the anode material provided in the second aspect of the present disclosure, and the preparation method thereof adopts the preparation method provided in the fourth aspect of the present disclosure. The test results of the above Examples 9-16 and Comparative Examples 4-6 are shown in Table 2 below.

TABLE 2
Performance test results of the anode materials in Examples 9-16 and
Comparative Examples 4-6

| | | | | | | | | 50-Week | |
|---|---|---|---|---|---|---|---|---|---|
| | | | | | | | | Pole | |
| | | | | | | First | First | Piece | 50-Cycle |
| | | | | | | Reversible | Coulombic | Expansion | Capacity |
| | A2 | B2 | F1 | F2 | (B2*F2)/ | Capacity | Efficiency | Rate | Retention |
| | Value | Value | Value | Value | (A2*F1) | (mAh/g) | (%) | (%) | Rate (%) |
| Example 9 | 7600 | 4050 | 0.19 | 0.08 | 0.22 | 2098 | 93.1 | 32.2 | 92.2 |
| Example 10 | 9800 | 7850 | 0.21 | 0.09 | 0.34 | 1855 | 92.7 | 33.4 | 92.0 |
| Example 11 | 7800 | 6550 | 0.17 | 0.06 | 0.29 | 2165 | 92.9 | 33.5 | 92.1 |
| Example 12 | 6700 | 3510 | 0.16 | 0.05 | 0.16 | 2094 | 92.5 | 31.9 | 93.5 |
| Example 13 | 7530 | 4130 | 0.15 | 0.07 | 0.25 | 2018 | 92.4 | 32.9 | 92.4 |
| Example 14 | 7100 | 3950 | 0.20 | 0.065 | 0.18 | 2098 | 93.1 | 32.2 | 92.2 |
| Example 15 | 6900 | 3660 | 0.23 | 0.06 | 0.14 | 2013 | 92.1 | 31.0 | 93.1 |
| Example 16 | 7140 | 3810 | 0.19 | 0.07 | 0.19 | 2004 | 92.6 | 31.6 | 92.8 |
| Comparative | 7700 | 7090 | 0.18 | 0.1 | 0.51 | 1811 | 88.2 | 43.1 | 85.9 |
| Example 4 | | | | | | | | | |
| Comparative | 7600 | 6350 | 0.19 | 0.08 | 0.352 | 1955 | 90.1 | 41.3 | 86.2 |
| Example 5 | | | | | | | | | |
| Comparative | 6890 | 10350 | 0.14 | 0.09 | 0.96 | 2001 | 89.9 | 46.1 | 80.1 |
| Example 6 | | | | | | | | | |

According to the data in Table 2, the anode material prepared in Examples 9 to 16 are prepared by uniformly filling the silicon material in the pores of the carbon matrix using the vapor deposition process. The deposition of the silicon material on the surface of the carbon matrix can be reduced by controlling deposition conditions, and the silicon material are effectively filled in the pores of the carbon matrix, improving the capacity of the anode material. Meanwhile, the size and shape of the silicon material can be controlled to ensure that the anode material not only can relieve volume expansion but also can maintain structural stability during cycling, reducing the collapse of the material structure caused by volume expansion of the anode material during the lithium intercalation and de-intercalation process, and effectively reducing the occurrence of side reactions between the anode material and the electrolyte, thereby improving the cycling performance of the anode material.

Compared with Example 9, in the preparation process of the anode material of Comparative Example 4, the time of the vapor deposition is too long, resulting in a larger particle size of silicon material. Meanwhile, the silicon material deposited on the surface of the carbon matrix are increased, resulting in a peak value B2 of the potential V between 380 mV and 470 mV becoming stronger, thereby leading to an increase in the value of (B2*F2)/(A2*F1). Most of the silicon material are deposited on the surface of the carbon matrix rather than in the pores, resulting in fewer and unevenly distributed silicon material within the pores, leading to an increase in the volume expansion of the anode material, a significant increase in the expansion rate of the pole piece, and a deterioration in the cycling performance of the anode material.

Compared with Example 9, in the preparation process of the anode material of Comparative Example 5, the average pore diameter of the carbon matrix is larger, resulting in a larger particle size of silicon material deposited in the pores of the carbon matrix, and leading to an intensified peak B2 at the position of 380 mV to 470 mV, thereby resulting in increased value of (B2*F2)/(A2*F1). The larger particle size of silicon material deposited in the pores results in significantly increased expansion rate of the pole piece, which leads to a decline in the structural stability of the anode material and intensifies the side reactions with the electrolyte, thereby worsening the cycling performance of the anode material.

Compared with Example 9, in the preparation process of the anode material of Comparative Example 6, the temperature during the vapor deposition is too high, causing the silicon material to undergo secondary growth, and forming larger silicon material. The silicon material may be converted from amorphous silicon to crystalline silicon at a high temperature, resulting in a peak value B2 at a position of 380 mV to 470 mV becoming stronger, thereby leading to a significant increase in the value of (B2*F2)/(A2*F1). The silicon material are difficult to deposit in the pores of the carbon matrix, and the silicon material deposited on the surface of the carbon matrix are significantly increased, resulting in a significant increase in the volume expansion of the anode material, a sharp increase in the pole piece expansion rate, and a greater tendency for collapse of the material structure during the lithium intercalation process, which intensified the side reactions between the anode material and the electrolyte, thereby significantly deteriorating the cycling performance of the anode material.

What is claimed is:

1. An anode material, comprising an active material, wherein the active material comprises a carbon matrix and a silicon material, the carbon matrix has pores, and at least part of the silicon material are distributed in the pores of the carbon matrix;
an anode prepared from the anode material acts as a working electrode, a metal lithium acts as a reference electrode, the metal lithium acts as a counter electrode, and an electrolyte contains metal lithium ions, wherein the working electrode, the reference electrode, the counter electrode and the electrolyte form a three-electrode battery to perform charging and discharging, and
when the anode material is electrified in a de-intercalation direction, a graph of a relationship between a differential value dQ/dV and a potential V of the working electrode is obtained,
wherein the differential value dQ/dV is obtained by differentiating the potential V of the working electrode based on the reference electrode to a charge and discharge capacity Q; and
in the graph of the relationship between the differential value dQ/dV and the potential V, the differential value dQ/dV between 20 mV and 80 mV of the potential V has a maximum peak value A1, and the differential value dQ/dV between 120 mV and 210 mV of the potential V has a maximum peak value B1, where B1/A1≤4.

2. The anode material according to claim 1, wherein the anode material has a porosity ranging from 40% to 60% after removing the silicon material.

3. The anode material according to claim 1, wherein the anode material has a total pore volume ranging from 0.001 cm³/g to 0.1 cm³/g.

4. The anode material according to claim 1, wherein the carbon matrix comprises at least one of hard carbon, soft carbon, graphite, mesocarbon microbeads, activated carbon, porous carbon, mesoporous carbon, or carbon gel.

5. The anode material according to claim 1, wherein the anode material has at least one of following technical features:
(1) the anode material has a total pore volume greater than or equal to 0.4 cm³/g after removing the silicon material;
(2) the anode material are provided with pores after removing the silicon material, wherein the pores comprise micropores, and a volume ratio of the micropores in a total pore volume of the anode material is greater than or equal to 80%; and
(3) an average pore diameter of pores formed after removing the silicon material from the anode material is less than or equal to 5 nm.

6. The anode material according to claim 1, wherein the silicon material comprise at least one of amorphous silicon, crystalline silicon, silicon oxide, silicon alloy, a composite of crystalline silicon and amorphous silicon, and a silicon-carbon composite.

7. The anode material according to claim 1, wherein the silicon material have average particle size ranging from 1 nm to 500 nm.

8. The anode material according to claim 1, wherein a mass content of silicon element in the silicon material is greater than or equal to 99%.

9. The anode material according to claim 1, wherein the anode material further comprises a carbon layer located on at least part of a surface of the active material.

10. The anode material according to claim 1, wherein the anode material has a median particle diameter D50 less than or equal to 10 μm.

11. The anode material according to claim 1, wherein the anode material has a specific surface area less than or equal to 5 m²/g.

12. An anode material, comprising an active material, wherein the active material comprises a carbon matrix and a silicon material, the carbon matrix has pores, and at least part of the silicon material are distributed in the pores of the carbon matrix;
an anode prepared from the anode material acts as a working electrode, a metal lithium acts as a reference electrode, the metal lithium acts as a counter electrode, and an electrolyte contains metal lithium ions, wherein the working electrode, the reference electrode, the counter electrode and the electrolyte form a three-electrode battery to perform charging and discharging, and
when the anode material is electrified in a de-intercalation direction, a graph of a relationship between a differential value dQ/dV and a potential V of the working electrode is obtained,
wherein the differential value dQ/dV is obtained by differentiating a potential V of the working electrode based on the reference electrode to a charge and discharge capacity Q; and
in the graph of the relationship between the differential value dQ/dV and the potential V, the differential value dQ/dV between 200 mV and 350 mV of the potential V has a maximum peak value A2, with a half-peak width F1, and the differential value dQ/dV between 380 mV and 470 mV of the potential V has a maximum peak value B2, with a half-peak width F2, where A2>B2, and a following relationship is satisfied: (B2*F2)/(A2*F1)≤0.35.

13. The anode material according to claim 12, wherein the carbon matrix comprises at least one of hard carbon, soft carbon, graphite, mesocarbon microbeads, activated carbon, porous carbon, mesoporous carbon, or carbon gel.

14. The anode material according to claim 12, wherein the anode material has at least one of following technical features:
(1) the anode material has a total pore volume greater than or equal to 0.4 cm³/g after removing the silicon material;
(2) the anode material are provided with pores after removing the silicon material, wherein the pores comprise micropores, and a volume ratio of the micropores in a total pore volume of the anode material is greater than or equal to 80%; and
(3) an average pore diameter of pores formed after removing the silicon material from the anode material is less than or equal to 5 nm.

15. The anode material according to claim 12, wherein the silicon material comprise at least one of amorphous silicon, crystalline silicon, silicon oxide, silicon alloy, a composite of crystalline silicon and amorphous silicon, and a silicon-carbon composite.

16. The anode material according to claim 12, wherein the silicon material have average particle size ranging from 1 nm to 500 nm.

17. The anode material according to claim 12, wherein a mass content of silicon element in the silicon material is greater than or equal to 99%.

18. The anode material according to claim 12, wherein the anode material further comprises a carbon layer located on at least part of a surface of the active material.

19. The anode material according to claim 18, wherein the carbon layer comprises at least one of graphitic carbon and amorphous carbon.

20. A lithium ion battery, comprising the anode material according to claim 12.
